(19) United States
(12) Patent Application Publication
(10) Pub. No.: US 2022/0071469 A1
(43) Pub. Date: Mar. 10, 2022

(54) AUTOMATICALLY MOVING FLOOR TREATING DEVICE

(71) Applicant: Vorwerk & Co. Interholding GmbH, Wuppertal (DE)

(72) Inventor: Marc PAPENHEIM, Wuppertal (DE)

(73) Assignee: Vorwerk & Co. Interholding GmbH, Wuppertal (DE)

(21) Appl. No.: 17/468,778

(22) Filed: Sep. 8, 2021

(30) Foreign Application Priority Data
Sep. 9, 2020 (DE) 10 2020 123 542.9

(51) Int. Cl. A47L 11/40

(52) U.S. Cl. CPC A47L 11/4061; A47L 11/4066; A47L 11/4011

(57) ABSTRACT

An automatically moving floor treating device has an electric motor-driven drive, an obstacle detection device, a sensor system, and an evaluation and control device. To analyze further properties of the floor surface, the evaluation and control device controls the drive of the floor treating device so that the floor treating device rotates around a defined location point of the floor surface. The evaluation and control means is furthermore configured to evaluate the parameter, which is detected by the sensor system during the rotation or movement of the floor treating device around the defined location point of the floor surface, and to determine an angle-dependent anisotropy of the parameter of the floor surface based on an anisotropy of the parameter of the floor surface based on defined different directions in space of the surrounding area, and to enter them in the surrounding area map by specifying an angular coordinate.

### CROSS REFERENCE TO RELATED APPLICATIONS

Applicant claims priority under 35 U.S.C. § 119 of German Application No. 10 2020 123 542.9 filed Sep. 9, 2020, the disclosure of which is incorporated by reference.

### BACKGROUND OF THE INVENTION

### 1. Field of the Invention

The invention relates to an automatically moving floor treating device comprising an electric motor-driven drive means for moving the floor treating device within a surrounding area, an obstacle detection means for detecting obstacles in the surrounding area, a sensor system for detecting a parameter of a floor surface, which is navigated by the floor treating device, and an evaluation and control means for creating a surrounding area map from the detected obstacle data and the parameters.

### 2. Description of the Related Art

Automatically moving floor treating devices are well known in the prior art. They can be, for example, cleaning robots, such as vacuum cleaner and/or mopping robots, polishing robots, waxing robots, mowing robots, or others. For the automatic movement, the floor treating devices have a navigation means, which detects surrounding area parameters and stores them in a surrounding area map. Based on the surrounding area map, an evaluation and control means of the floor treating device can plan a traveling route, along which, for example, floor treating activities are performed by the floor treating device.

It is furthermore known in the prior art to equip floor treating devices of this type with a floor detection means, which records parameters of the floor to be treated, for example detects a floor type. A floor treating device, which is equipped as cleaning device can recognize, for example by means of such a detection means, whether it travels on a carpeted floor, a wood floor, or a tiled floor, and, as a function thereof, can plan a floor treating activity, in particular control a treating intensity, a water application, a speed of a rotating floor treating element, a suction power level of a suction blower, or the like. Cameras, which recognize a structure of the floor surface with the help of an image processing means and classify said floor surface as a certain floor type, are known, for example, as detection means for the detection of a floor type. It is furthermore also known to equip floor treating devices with resistance sensors or slip sensors, which detect a parameter, which is a function of a friction between the floor treating device and the floor surface to be treated.

Even though floor treating devices and floor detection means of this type have proven themselves in order to recognize the type of floor surfaces of the surrounding area and to record them accordingly in the surrounding area map, the type of the floor surface is not examined in more detail, for example with regard to a preferred direction, which results from an installation direction of wooden floorboards or tiles, or from a pole direction of carpet fibers.

### SUMMARY OF THE INVENTION

Based on the above-mentioned prior art, it is thus the object of the invention to examine further properties of the floor surface, which can be considered in an advantageous manner when planning a traveling strategy of the floor treating device.

To solve the above-mentioned object, it is proposed that the evaluation and control means of the floor treating device is configured to control the drive means of the floor treating device in such a way that the floor treating device rotates around a defined location point of the floor surface, and wherein the evaluation and control means is furthermore configured to evaluate the parameter, which is detected by means of the sensor system during the rotation or movement of the floor treating device around the defined location point of the floor surface, and to determine an anisotropy of the parameter of the floor surface based on defined different directions in space of the surrounding area, and to enter them in the surrounding area map by specifying an angular coordinate.

According to the invention, the floor treating device now has a sensor system, which is suitable to detect a directional dependence of floor parameters of the floor surface. Such a directional dependence is at hand if, based on different directions in space of the surrounding area, in particular in different directions parallel to the floor surface, the floor surface has different properties. For example a wood floor, which can be treated better in the fiber direction of the wood than orthogonally thereto, is an example for a directional dependence of floor properties. A tile floor, the joint direction of which is essential for, for example, a cleaning result of the floor surface, is another example. The parameters of the floor surface, however, do not have to refer only to cleaning activities, on the contrary, the situation can quite simply also be such that a floor surface can be traversed particularly easily in a certain direction, i.e. has a smaller frictional resistance than in another direction. The directionally dependent properties of the floor, i.e. the anisotropy of the floor, can then also be considered when planning a moving strategy of the floor treating device. The directional dependence of the floor properties is preferably initially determined over the entire floor surface, wherein a detection according to the invention of the anisotropy preferably takes place at a plurality of location points. This means that the detection means rotates in succession around the respective defined location point at different location points of the surrounding area, wherein the evaluation and control means subsequently evaluates the detected parameter and determines an angle-dependent anisotropy based on the respective location point. Due to the knowledge of the current location and of the current orientation of the floor treating device within the surrounding area or within a surrounding area map, respectively, a conclusion can then be drawn to a global direction of the surrounding area within the surrounding area map from a direction, which is locally defined based on the current location point of the floor treating device. The measuring values, which were detected at different location points of the surrounding area, can then thus be consolidated in a common global surrounding area map. The direction in the surrounding area map is defined with the help of an angular coordinate, preferably with the help of polar coordinates. For the detection of the floor parameters as well as the creation of the surrounding area map, an exploration mode of the floor treating device can be performed, during which the floor treating device moves in the surrounding area without performing floor treating activities, and detects the parameters of the floor surface there or also determines obstacles, which may additionally also be present in the surrounding area, respectively, which can likewise be used to create the surrounding area map. In the alternative, it is possible to detect the parameters of the floor surface and optionally the obstacle data while performing one or several floor treating activities. In any case, it is advantageous to consider that the floor surface can also have anisotropic properties, which vary as a function of the location.

In particular in the case of natural floors, but also as a function of an installation type of floor surfaces, it can happen, for example, that the properties vary from location to location due to the appearance of a natural grain, of a knothole, of a joint, or the like. It is thus advisable to perform a detection according to the invention of floor parameters in a plurality of directions in space at different location points of the floor surface. The detection in different directions in space can thereby be, for example, an all-around detection over a field of view of 360 degrees around the location point. The detection can thereby take place steadily or only in a plurality of discrete directions, for example in four directions, which are offset by 90 degrees. Those directions, in which the parameters of the floor surface are to be measured, can be based on a fixed point of the floor treating device, or on the coordinates of the surrounding area map. While performing floor treating activities, the evaluation and control means of the floor treating device can also compare stored parameter anisotropies of the floor surface to a currently detected anisotropy of the respective parameter of the floor surface. If the currently determined anisotropy deviates from the stored anisotropy, this can be considered, for example, as existence of dirt on the floor surface. Such information can then be output, for example, to a user, or can lead to an automatically started cleaning of the corresponding area of the floor surface. If the anisotropy of the floor surface does not change at all for a longer period of time, this can furthermore suggest that the navigated floor is worn out. Such information can also be transferred to the user.

According to the invention, the floor treating device performs a natural rotation around the defined location point, wherein it rotates around itself in a 360 degree rotation. This can likewise also take place at a plurality of defined location points of the surrounding area, in particular when there is no information yet about whether only a single floor type is present on the floor surface, or whether several floor types are present, or a floor type itself has inhomogeneous properties. The rotation of the floor treating device can take place clockwise, counterclockwise, or also sequentially in time in both directions, depending on whether other or additional information can possibly be obtained in the opposite direction.

It is proposed in particular that the evaluation and control means is configured to form an average value of the angle-dependent anisotropy from a plurality of detections at different location points of the surrounding area. By means of the formation of an average value, the plurality of detection results is thus considered, which were determined in an identical direction in space, based on different location points of the surrounding area. That direction in space of the surrounding area can thus be determined, in which a movement of the floor treating device preferably takes place, because, for example, a low-friction preferred direction exists there for the moving activity or a floor treating activity of the floor treating device. Instead of an average value, local values of the anisotropy can also be stored in the surrounding area map. This is advantageous, for example for a local spot treatment of the floor surface.

It is furthermore proposed that the sensor system is configured to detect a power consumption of the drive means which can in particular be measured during the movement of the floor treating device. The power consumption of the drive means changes as a function of the properties of the floor surface, for example when the floor treating device has to cross joints during the movement or when a direction of movement changes such that it suddenly travels opposite to a pile direction of a carpeted floor. The floor surface thus uses a force, which results in a higher power consumption of the drive motor, to oppose the drive means of the floor treating device. This can preferably be evaluated in order to determine the anisotropy of the floor surface, i.e. to detect the angle-dependent properties of the floor surface.

The sensor system can likewise also be configured to detect a power consumption, in particular a change of a power consumption, for the drive of an electric motor-driven floor treating element of the floor treating device. The floor treating element can in particular be a floor treating element, which is driven in a rotating or oscillating manner, such as, for example, an oscillating wiping plate or a rotating brush element. An electric motor-driven floor treating element can furthermore also be a blower, by means of which, for example, dust is absorbed from a floor surface, which is to be cleaned. The power consumption of a drive means or of a floor treating unit can thus be evaluated as measuring method for determining an anisotropic property of the floor surface, for example of a friction coefficient. It can thus be determined for each location point of the surrounding area, in which direction which floor properties are present. The proposed direct detection via a power change uses the fact that the power consumption of the electrical consumer, which ensures the drive, changes when different properties of the floor surface exist. For example, the power consumption of a drive for rollers, brushes, actively driven cleaning pads, and drive wheels thus changes, but also the power consumption of a blower. The detected measuring values can be current values, voltage values, power values, but also a phase angle or slip.

The sensor system can furthermore have a microphone, which is configured to detect noises created by moving over the floor surface by means of the floor treating device. This type of detection uses the fact that different friction properties of the floor surface also create other noises in different directions in space, because for example the wheels of the floor treating device have to overcome a larger frictional resistance in certain directions of movement. The resulting noises can thus become louder or quieter or can also have a different frequency. The noises are recorded by means of the microphone and are then evaluated with respect to the direction of movement by means of the evaluation and control means.

It can furthermore be provided that the sensor system is configured to detect a natural oscillation of a device subregion of the floor treating device. A change of a natural oscillation of a device subregion of the floor treating device can in particular be detected. The sensor system can preferably have an acceleration sensor and/or a gyroscope. In the case of this indirect type of detection, impacts of a floor anisotropy are determined, which appear during the operation or the movement, respectively, of the floor treating device. During a movement, the floor treating device usually oscillates minimally. Due to a property change of the floor surface, these oscillations of the floor treating device or of individual device subregions, respectively, of the floor treating device change. These changes can then be detected, for example, with the help of an acceleration sensor and/or gyroscope. The position of the sensor at the floor treating device can thereby generally be selected freely, because vibrations of this type usually appear everywhere in the floor treating device. However, at least one optimal position is always provided, at which the oscillations appear particularly strongly or change particularly strongly, respectively. The person of skill in the art will be able to determine the best placement of such a sensor at the floor treating device.

All above-mentioned detection types can also be combined with further detection methods, for example by means of the additional taking of camera images, which reflect a structure, in particular a preferred direction of the floor surface. The evaluation and control means of the floor treating device then preferably has an image processing program in order to determine the direction-dependent properties of the floor surface. A slip of drive wheels on the floor surface in different directions of movement of the floor treating device or directions in space of the surrounding area, respectively, can furthermore also be determined.

It can in particular be provided that the evaluation and control means is configured to specify a strategy for moving the floor treating device within the surrounding area as a function of the determined angle-dependent anisotropy of the parameter of the floor surface. According to this preferred design, it is thus determined in which direction (starting at a defined location point) optimal properties for, for example, a most intensive, quickest, or most energy-saving cleaning or movement lie. For example, a pole direction of a carpeted floor, i.e., a preferred direction of the carpet fibers, can be used to perform a movement of the floor treating device preferably in this direction. The floor treating device can thus move with particularly low friction and thus in an energy-saving manner. When the floor treating device is to perform, for example, a vacuum cleaning of the floor surface or a mopping of the floor surface, it is advisable to plan the moving strategy in such a way that the movement and floor treating activity takes place parallel to a longitudinal extension of a joint or grain or structure of the floor surface.

The evaluation and control means can in particular be configured to additionally specify the strategy for the movement as a function of the type of a floor treating activity, which is performed during the movement, wherein the floor treating activity is characterized according to one of the following parameters: intensity of the floor treatment, speed of the floor treatment, use of consumables during the floor treatment, wear of the floor surface due to the floor treatment, energy consumption during the floor treatment. The moving strategy or also floor treating strategy of the floor treating device is thus determined as a function of the floor properties, which are stored in the surrounding area map. That strategy is thereby determined, which is best suited for the respective situation. The strategy can thereby be a cleaning mode, which requires a certain cleaning power, a certain water consumption, a certain energy consumption, a certain cleaning time, or the like. The floor surface is thus advantageously traversed in that direction, which is most advantageous for the desired floor treatment or movement. It is possible thereby to work with the averaged direction-dependent floor properties on the one hand, or in the alternative or addition, to also work with local floor properties. As a whole, a moving strategy, in particular direction of movement, is thus determined for the floor treating device, in which particularly optimal floor properties are present. Vice versa, it is also possible that a movement or a floor treating activity is adapted as a function of a traveling direction, in that properties of the floor treating device are changed, for example a motor power or a contact pressure on the floor surface is varied. For example, an amount of liquid applied to the floor surface or a temperature of cleaning material, a speed of a rotating cleaning element, an oscillation frequency of an oscillating mopping element, or the like can likewise be adapted. Moving properties, such as speed, can furthermore be adapted.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a floor treating device according to the invention at a location point of a surrounding area;

FIG. 2 shows a surrounding area map with a layout of the surrounding area and location points recorded therein;

FIG. 3 shows a spiral trajectory according to a first embodiment;

FIG. 4 shows a spiral trajectory according to a further embodiment;

FIG. 5 shows a surrounding area map with trajectories stored therein at different location points; and

FIG. 6 shows a surrounding area map with stored direction specifications as well as a planned treatment path.

### DETAILED DESCRIPTION OF PREFERRED EMBODIMENTS

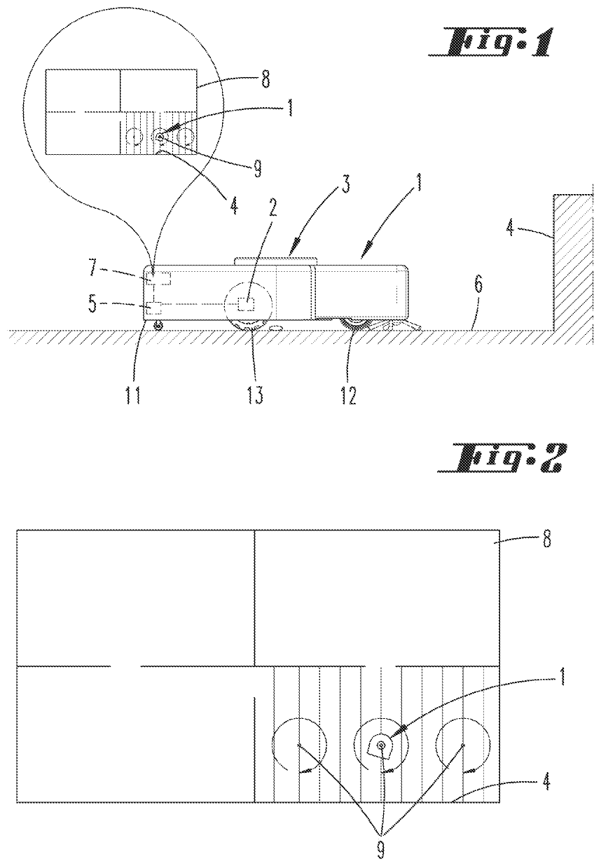

FIG. 1 initially shows an exemplary automatically moving floor treating device 1, which is formed, for example, as cleaning robot here. The floor treating device 1 has a drive means 2 in the form of an electric motor for motor-driven wheels 13. The electric motor as well as further electrical consumers of the floor treating device 1 are supplied with energy by means of an energy storage, which is not illustrated here, in particular an accumulator. The floor treating device 1 furthermore has an obstacle detection means 3, which is configured to detect distances to obstacles 4, which are present in the surrounding area of the floor treating device 1. Here, an obstacle detection means 3 is, for example, an optical distance measuring means in the form of a laser triangulation measuring means. The obstacle detection means 3 emits, for example, a laser beam, which rotates by 360 degrees and which strikes obstacles 4 and is reflected thereon. From the obstacles 4, a conclusion can be drawn to a distance of the floor treating device 1 by means of the reflected radiation. With the help of an evaluation and control means 7 of the floor treating device 1, the detection signals of the obstacle detection means 3 are processed into a surrounding area map 8, which includes a layout of the surrounding area with obstacles 4 stored therein as well as a current natural position of the floor treating device 1 at a location point 9. For the floor treatment of a floor surface 6 of the surrounding area, the floor treating device 1 furthermore has a floor treating element 12, here for example a brush roller, which rotates around an essentially horizontal axis. An electric motor, which is not illustrated here and which is used to drive the floor treating element 12, is also assigned to the floor treating element 12. The floor treating device 1 furthermore has a sensor system 5, which is formed and configured to detect a parameter of the floor surface 6, which is navigated by the floor treating device 1. Here, the sensor system 5 is assigned, for example, to the drive means 2 of the wheels 13. The sensor system 5 detects a power consumption or a change, respectively, of a power consumption of the drive means 2, and, as a function thereof, can draw a conclusion to one or several parameters of the floor surface 6. The surrounding area map 8 is used by the evaluation and control means 7 of the floor treating device 1 in order to plan a treatment path 14 of the floor treating device 1.

The invention will now be described in more detail on the basis of FIGS. 2 to 6.

To detect a parameter of the floor surface 6 of the surrounding area, and to thus improve the information, which is stored in the surrounding area map 8 and which is used for a planning of a treatment path 14 based thereon, the evaluation and control means 7 of the floor treating device 1 is configured to control the floor treating device 1 along certain trajectories 10 of the floor treating device 1, along which the sensor system 5 then detects parameters of the traversed subregions of the floor surface 6. A surrounding area map 8 with several rooms is illustrated in an exemplary manner in FIG. 2, wherein one of the rooms has wooden floorboards here, which are installed, for example, in parallel. To obtain information about the direction, in which the wooden floorboards are installed within the surrounding area, the evaluation and control means 7 controls the drive means 2 of the floor treating device 1 in such a way that the floor treating device 1 performs a natural rotation around the respective location point 9 at, for example, three location points 9 here. Here, the rotation takes place clockwise only as an example, but can alternatively or additionally also take place counterclockwise. During the natural rotation of the floor treating device 1, the sensor system 5 detects a power consumption of the drive means 2 for the wheels 13 of the floor treating device 1. Based on each location point 9, the power is thereby stored individually as a function of a current angle of rotation of the floor treating device 1 around the location point 9. The evaluation and control means 7 then evaluates the determined power consumption or change of the power consumption as a function of the assigned angle of rotation of the floor treating device 1, and stores the determined angle-dependent anisotropy of the floor surface 6 for the detected parameter “power consumption”. An angle-dependent amount of the respective measuring parameter can be stored in this way for each location point 9, wherein other measuring parameters can also be detected, which vary as a function of the properties of the floor surface 6, alternatively or additionally to the measuring parameter “power consumption”. A power consumption of a drive means for the floor treating element 12 can also be considered alternatively to a detected power consumption of the drive means 2 of the wheels 13. The sensor system 5 can furthermore also be configured to detect a natural oscillation of a device subregion 11, to which the floor treating device 1 or the device subregion 11 thereof, respectively, is subjected due to the rotation around the location point 9 and the respective angle-dependent structure of the floor surface 6. The natural oscillation of the device subregion 11 can in particular be detected by means of an acceleration sensor or a gyroscope. Even though this is not further illustrated here, further or additional types of sensor system 5 can furthermore also be used. For example, the sensor system 5 can have a microphone, which is configured to detect noises, which are generated during a traversing of the floor surface 6 by means of the floor treating device 1. With this type of indirect detection, the natural oscillations and/or noises of the floor treating device 1, which occur during a movement or rotation around the location point 9 and which change as a function of the properties of the floor surface 6, are used. The position for the sensor system 5 for detecting natural oscillations can generally be selected at every device subregion 11 of the floor treating device 1. Depending on the design of the floor treating device 1, the person of skill in the art will find that device subregion 11, which reacts particularly sensitively to property changes of the floor surface 6, i.e. that device subregion 11, which shows a change of the frequency of the natural oscillation particularly clearly as a function of the direction of movement of the floor treating device 1 on the floor surface 6.

The floor treating device 1 can either rotate around the location point 9 during the performance of a floor treating activity or can do so as part of an exploration operation. Provided that a floor treating activity is performed at the same time, for example by using a floor treating element 12, measuring parameters can in particular also be used, which are a function of the type of a floor treating activity, namely for example when the floor treating device 1 applies a liquid to the floor surface 6, vacuums the floor surface 6, or the like. Not only for example a power change of a drive means 2 for the floor treating element 12 due to the change of a friction coefficient of the floor surface 6 can then be detected thereby in an angle-dependent manner, but, for example, also an angle-dependent water absorption of a floor covering or air permeability of the floor surface 6. Starting at each location point 9 of the floor surface 6, it can thus additionally be determined, in which direction ideal parameters for a low-friction movement, liquid-saving floor treatment, or the like are present in which direction, starting at the location point 9. Angle-dependent profiles, which specify the parameter of the floor surface 6, based on a certain floor treating activity, can thus also be created in a location-dependent manner. Based on this, a particularly advantageous moving strategy can be determined for the floor treating device 1 during a certain floor treating activity. In the concrete example of FIG. 2, an angle-dependent profile of the floor surface 6, which refers to a movement of the floor treating device 1 on the floor surface 6 with as little friction as possible, can be created, for example based on each location point 9. Due to the fact that they are, for example, wooden floorboards, which are installed in parallel, the floor treating device 1 experiences a larger resistance during its rotation, when the rolling direction of the wheels 13 is orthogonal to the joints, which run between wooden floorboards, which are installed in parallel. The frictional resistance is therefore smaller when the wheels 13 rotate parallel to the longitudinal extension of the illustrated wooden floorboards. In addition or in the alternative, the frictional resistance can also be increased, when the wheels 13 are orthogonal to a grain direction of the wood structure. The respective angle-dependent resistance is noticeable due to the power consumption or change of the power consumption, respectively, of the drive means 2.

With the knowledge of the respective current location of the floor treating device 1 at the location point 9 as well as the respective orientation of the floor treating device 1, an angle-dependent total structure of the floor surface 6 is then calculated from several angle-dependent profiles at different location point 9 of the floor surface 6, which specify the anisotropy of the considered parameter of the floor surface 6. Graphically illustrated, this can correspond, for example, to the strip-like structure of the installed wooden floorboards.

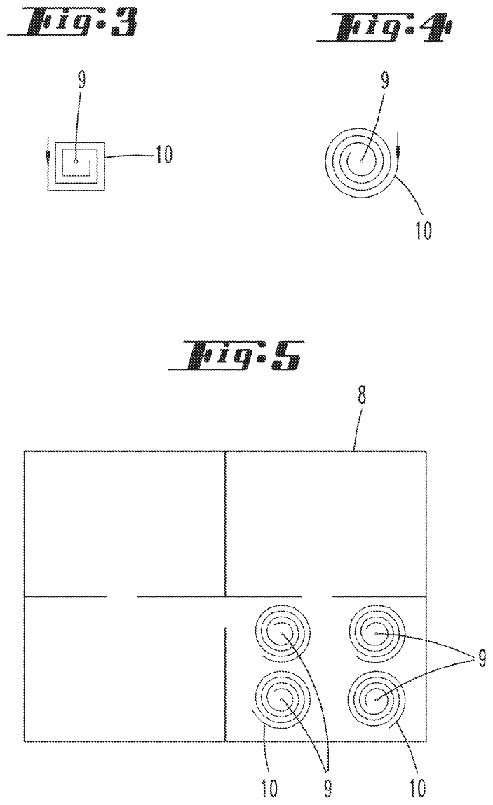

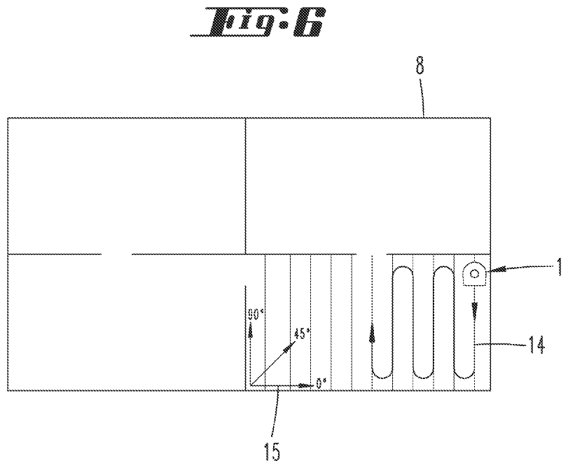

FIGS. 3 and 4 show two different types of spiral trajectories 10, which the floor treating device 1 can perform as an alternative to a rotation at the location point 9, in order to detect anisotropic properties of the floor surface 6. FIG. 3 shows a rectangular spiral counterclockwise trajectory 10, while FIG. 4 describes a circular spiral clockwise trajectory 10. It goes without saying that it is also possible that the rectangular shape is passed through clockwise, and the circular shape counterclockwise. The trajectory 10 can comprise the entire floor surface 6, or, for example, only a certain subregion of a floor surface 6. In the alternative, it is also possible, as illustrated in FIG. 5, to move along several spiral trajectories 10 around different location points 9 of the floor surface 6. The detection values of the parameter, which are determined during the movement and which are a function of the angle of the respective orientation of the floor treating device 1, can then likewise be averaged again for several different location points 9 and/or different points on the spiral trajectory 10.

As illustrated in FIG. 6, the angle-dependent parameters of the floor surface 6 are recorded in the surrounding area map 8 with direction specifications 15, wherein the direction specification 15 includes an angle specification of 0 degrees to 90 degrees here, and can generally have any origin, here only as an example an origin in a corner of a room of the layout. The parameter, which is illustrated in an angle-dependent manner, results here according to the installation direction of the wooden floorboards as pattern with strips, which run parallel to one another, wherein each strip runs in 90 degrees direction and specifies that direction of movement or floor treating direction, along which the floor treating device 1 can operate in a particular energy-saving manner and/or quickly. Orthogonally thereto, i.e. in a direction with the direction specification 15 “0 degrees”, the floor treatment or movement, respectively, of the floor treating device 1 is made more difficult in that the floor treating device 1 has to cross the joints between the wooden floorboards, which are installed in parallel.

With the knowledge of the direction specification 15 recorded in the surrounding area map 8, the evaluation and control means 7 of the floor treating device 1 can then plan a treatment path 14 for the floor treating device 1, along which the floor treating device 1 travels particularly preferably and performs its floor treating activity. A treatment path 14 of this type is illustrated here in an exemplary manner in FIG. 6 and runs in a meander-shaped manner, wherein the large straight portions of the meander are aligned parallel to the joints of the wooden floorboards, which simultaneously corresponds to that direction on the floor surface 6, in which the floor surface 6 can be crossed or treated, respectively, in a particularly low-friction and thus energy-saving manner by the floor treating device 1.

The strategy for movement of the floor treating device 1 determined by the evaluation and control means 7 can also be determined by using other detected parameters of the floor surface 6, for example the level of consumables during a floor treatment along a specified direction, the level of wear of the floor surface 6 in a certain direction of the floor surface 6, the quality of the attained floor treating result in a certain direction, or others.

Although only a few embodiments of the present invention have been shown and described, it is to be understood that many changes and modifications may be made thereunto without departing from the spirit and scope of the invention.

### LIST OF REFERENCE NUMERALS

1 floor treating device
2 drive means
3 obstacle detection means
4 obstacle
5 sensor system
6 floor surface
7 evaluation and control means
8 surrounding area map
9 location point
10 trajectory
11 device subregion
12 floor treating element
13 wheel
14 treatment path
15 direction specification

What is claimed is:

1. An automatically moving floor treating device comprising:
an electric motor-driven drive configured for moving the floor treating device within a surrounding area,
an obstacle detection device configured for detecting obstacles in the surrounding area,
a sensor system configured for detecting a parameter of a floor surface, which is navigated by the floor treating device, and
an evaluation and control device for creating a surrounding area map from the detected obstacle data and the parameters,
wherein the evaluation and control device is configured to control the drive of the floor treating device in such a way that the floor treating device rotates around a defined location point of the floor surface, and
wherein the evaluation and control device is configured to evaluate the parameter, which is detected by means of the sensor system during the rotation or movement of the floor treating device around the defined location point of the floor surface, and to determine an anisotropy of the parameter of the floor surface based on defined different directions in space of the surrounding area, and to enter the defined different directions in the surrounding area map by specifying an angular coordinate.

2. The floor treating device according to claim 1, wherein the evaluation and control device is configured to form an average value of the angle-dependent anisotropy from a plurality of detections at different location points of the surrounding area.

3. The floor treating device according to claim 1, wherein the sensor system is configured to detect a power consumption or change of power consumption of the drive.

4. The floor treating device according to claim 1, wherein the sensor system is configured to detect a power consumption or a change of a power consumption for a drive of a floor treating element of the floor treatment device, the drive of the floor treating element being electric motor-driven in a rotating or oscillating manner.

5. The floor treating device according to claim 1, wherein the sensor system has a microphone, which is configured to detect noises created by moving over the floor surface by means of the floor treating device.

6. The floor treating device according to claim 1, wherein the sensor system is configured to detect a natural oscillation, or a change of a natural oscillation, of a device subregion of the floor treating device, wherein the sensor system has an acceleration sensor and/or a gyroscope.

7. The floor treating device according to claim 1, wherein the evaluation and control device is configured to specify a strategy for moving the floor treating device within the surrounding area as a function of the determined angle-dependent anisotropy of the parameter of the floor surface.

8. The floor treating device according to claim 7, wherein the evaluation and control device is configured to additionally specify the strategy for the movement as a function of a type of a floor treating activity, which is performed during the movement, wherein the floor treating activity is characterized according to one of the following parameters: intensity of the floor treatment, speed of the floor treatment, use of consumables during the floor treatment, wear of the floor surface due to the floor treatment, energy consumption during the floor treatment.
